(19) United States
(12) Patent Application Publication
(10) Pub. No.: US 2013/0024349 A1
(43) Pub. Date: Jan. 24, 2013

(54) METHOD FOR TRADING STOCKS

(71) Applicants: Mageshkumar Venkatesan, Petaluma, CA (US); Balamurugan Vellore Gangadharan, Bangalore (IN); Satyanarayana Gupta, Bangalore (IN); Romeo Quiocho, Pleasant Hill, CA (US); Manit Kumar Gomber, Bangalore (IN); Jai Chandra Yadav, Bangalore (IN); Gregory S. Farber, Greenbrae, CA (US)

(72) Inventors: Mageshkumar Venkatesan, Petaluma, CA (US); Balamurugan Vellore Gangadharan, Bangalore (IN); Satyanarayana Gupta, Bangalore (IN); Romeo Quiocho, Pleasant Hill, CA (US); Manit Kumar Gomber, Bangalore (IN); Jai Chandra Yadav, Bangalore (IN); Gregory S. Farber, Greenbrae, CA (US)

(73) Assignee: Incredible Signals Inc., Las Vegas, NV (US)

(21) Appl. No.: 13/469,017

(22) Filed: May 10, 2012

Related U.S. Application Data
(60) Provisional application No. 61/518,825, filed on May 10, 2011.

(51) Int. Cl. G06Q 40/04

(52) U.S. Cl. 705/37

(57) ABSTRACT

The present invention provides a trading system with very high percent success rate in market by means of minimizing the risk. This invention provides an easy and simple-to-use system for swing trading. This system is automated and based on an algorithm which uses the end of the day data for particular financial instrument to generate buy/sell signals for selected stocks. These signals provide the precise entry and exit points in the markets for those particular stocks. The signals come with a small stop loss to ensure safety of the investment. The system provides three exit levels to ensure that the investment risk is minimized and profit is reaped.

### CROSS-REFERENCE TO RELATED APPLICATION

This application claims priority to U.S. Provisional Application No. 61/518,825 filed on May 10, 2011.

### FIELD OF THE INVENTION

The present invention relates to a software-based system which may be employed by securities traders to minimize risk with respect to specific securities markets. The present invention provides a graphical display comprising signals with recommendations for trading securities.

This present invention contains material that is subject to copyright protection. The applicants have no objection to the facsimile or other electronic means of reproduction of this document, as it appears in the U.S. Patent and Trademark Office (USPTO) patent file or records or in any publication by the USPTO or counterpart foreign or international instrumentalities. The applicants otherwise reserve all copyrights whatsoever.

### BACKGROUND OF THE INVENTION

Swing trading is a speculative activity in financial markets and the swing traders repeatedly buy and sell instruments such as stocks, indexes, bonds, currencies or commodities at or near the end of up or down price swings caused by price volatility. A swing trading position is held longer than a day. However, it is shorter than investment strategies that can be held for months or years.

In swing trading it is common to utilize a set of objective rules for buying and selling as it eliminates the subjectivity, emotional aspects, and labor-intensive analysis of swing trading. A set of trading rules can be used to create a trading algorithm or trading system to predict the market. These trading algorithms or trading systems use either technical analysis and/or fundamental analysis and provide entry, exit, and stop loss trade price points. Technical analysis is a technique that can be used to attempt to forecast the future direction of security prices through the study of past pricing patterns, primarily by the use of price and volume charts. Trading algorithms are not exclusive to swing trading. These trading algorithms can also be used for day trading and long-term trading.

There has been tremendous interest in developing trading algorithms. For example, Alexander Elder, the author of several best-selling books on trading including “Come into my trading room: A complete guide to trading,” provides a simple rule-based approach for use in swing trading. This approach measures the behavior of an instrument's price trend using three different moving averages of closing prices. Under this approach, a particular instrument is traded long when the three averages are aligned in an upward direction and only traded short when the three averages are moving downward. Despite these efforts to develop appropriate algorithms, identifying when to buy and when to sell remains the primary challenge for all swing trading as well as long-term trend following trading strategies. It is generally held that all mathematical models or algorithms will not always work with every instrument and in every market situation. Risk in swing trading is commensurate with market speculation and there is a definite need to develop novel method to minimized risk and reap profits in swing trading.

In the present scenario, there are vendors who provide free/chargeable recommendations for stocks. These include trade entry and exit advisory instructions to general public and or subscribed customers on their web sites and via emails, SMSs, mobile phone applications etc. This service is either free or in some cases it is based on subscription charges. But none of these vendors provide help in the automated way to customers who are managing a trade that is in progress. An actual trade is never a simple exit and entry matter. It requires a meticulous management while the trade is still open and in progress. While many of them provide a manual signals, we have developed a method which calculates and projects the figures in a graphical manner as part of a price chart. The goal of our method is not just to give the single entry and exit recommendations but also help the customers/users manage the trade profitably by providing multiple exit recommendations to lock in profits at the right time and reducing the risk automatically.

While many of the vendors in swing trading provide signals manually based on expert opinion or otherwise, our method uses an algorithm based on combination of technical indicators on the backend and a flash based charting tool as the frontend where the subscriber is shown multiple exit recommendations to lock in profits at the right time and thus reduce the risk automatically.

The advanced internal logic of the present invention is designed to analyze and gauge stock's price fluctuations with uncanny accuracy. This helps the investor to pinpoint the low-risk, high-profitability entry points and exit points. The system according to the present invention is designed to help prevent the investor from making the two most common mistakes in trading, buying prematurely while the stock continues to drop in price, and buying too late, essentially at the top of the price cycle.

The stock performance chart according to the present invention has features to keep the investor in tune with the current market conditions, direction and momentum. The investor will always know when the market is strong, when it is weak and what direction it is headed. This will have an overwhelming impact on the trading decision the investor is going to make.

### SUMMARY OF THE INVENTION

We have invented a method to minimize risk in security trading. More particularly, we have invented a method to minimize risk in swing trading.

In one embodiment, the present invention provides a computer system comprising a frontend graphical display comprising signals with recommendation for trade. The signals may recommend buying a security, or selling a security or both buying and selling the security within a short span of time with the goal of minimizing the risk. The graphical display comprising the signals with recommendation for trade enables the trader to reduce the chance of loss and increase the chance of profits.

In one aspect, the signals in the graphic display at the frontend identify the time point at which the securities are traded at low price (relative to recent price action) and recommend the trader to buy the securities at that time. In another aspect, the signals in the graphic display in the frontend identify the time when the securities are traded at high price and recommend the trader to sell the securities at that point of time. In yet another aspect of the present invention, the signals in the graphic display at the frontend with the recommendation to sell securities also specify the percentage of securities to be sold at one point and the percentage of securities to be sold at another subsequent point in order to reap the reasonable maximum benefit for a short term swing trade. The recommendations to buy and sell are based on the price of the securities being traded.

In one embodiment of the present invention, the frontend system is represented by the computer at the trader's location. The frontend system is connected through a communication channel to a backend system. In one aspect of the present invention, the communication channel between the backend system and frontend system is a network-based and preferably based on the internet.

In yet another embodiment of the present invention, the backend system connected to the frontend system through communication channel is responsible for generating the graphic display comprising the signals with recommendation for trade. The backend system receives the market price data from variety of market participants including but not limited to NASDAQ, S&P 500, DJI. and BSE 500. The backend system may also receive the market data from service providers. In a preferred aspect of the present invention, the backend system receives end of day trading data either from a market participant or a service provider. The backend system, besides processing the data received from market providers for graphic display of performance of individual securities, uses an algorithm and generates signal with recommendations for trade. The signals may recommend either buying or selling a security based on the price of that security at that particular time. The signals recommending the trade are displayed at appropriate places in the graphic display.

The algorithm used by the backend system makes use of end of the day data for each of the securities to analyze the market data and provide trade recommendation for qualifying securities.

Other features and advantages of the present invention will be apparent to those of ordinary skill in the art upon reference to the following detailed description taken in conjunction with the accompanying drawings.

### BRIEF DESCRIPTION OF THE DRAWING

FIG. 1 is a block diagram illustrating the general architecture of the data systems in accordance with the embodiment of the present invention. Web Server is maintained by the provider of trading service according to the present invention. Web Server receives the stock data from third party providers. Subjecting the data received from third party providers, the Web server generates the trading trend using the algorithm of the present invention. The user accesses the Web Server through internet and receives the signals for trading one or more stocks on his web browser.

FIG. 2 is a flowchart illustrating the data update process in accordance with the algorithm used in the present invention.

FIG. 3 shows a typical representation of graphical display containing signals with recommendation for trade. This Figure provides the chart for the performance of stock of Tata Chemicals Ltd. Shown in the chart are inverted arrows that would have recommended the sale of the stocks at that time. The percentage provided adjacent to the inverted arrows represent the percentage of stocks that would have been recommended for sale at the price existing at that point of time. The upward pointing arrows represent the signal that would have recommended the purchase of the stocks at that time. The horizontal lines represent the stop loss price level. Also shown in this chart are (1) Top: Inverted ‘V’ Formation and (2) Bottom: ‘V’ Formation.

FIG. 4 shows a typical representation of graphical display containing signals with recommendation for trade. This Figure provides the chart for the performance of stock of Microsoft Corporation. Shown in the chart are inverted arrows that would have recommended the sale of the stocks at that time. The percentage provided adjacent to the inverted arrows represent the percentage of stocks that would have been recommended for sale at the price existing at that point of time. The upward pointing arrows represent the signal that would have recommended the purchase of the stocks at that time. The horizontal lines represent the stop loss price level.

FIG. 5 shows a typical representation of graphical display containing signals with recommendation for trade. This Figure provides the chart for the performance of stock of Steel Dynamics Inc. Shown in the chart are inverted arrows that would have recommended the sale of the stocks at that time. The percentage provided adjacent to the inverted arrows represent the percentage of stocks that would have been recommended for sale at the price existing at that point of time. The upward pointing arrows represent the signal that would have recommended the purchase of the stocks at that time. The horizontal lines represent the stop loss price level.

FIG. 6 shows a typical representation of graphical display containing signals with recommendation for trade. This Figure provides the chart for the performance of stock of Waters Corporation. Shown in the chart are inverted arrows that would have recommended the sale of the stocks at that time. The percentage provided adjacent to the inverted arrows represent the percentage of stocks that would have been recommended for sale at the price existing at that point of time. The upward pointing arrows represent the signal that would have recommended the purchase of the stocks at that time. The horizontal lines represent the stop loss price level.

FIG. 7 shows a typical representation of graphical display containing signals with recommendation for short trade. This Figure provides the chart for the performance of stock of Ansal Properties and Infrastructure Ltd. Shown in the chart are upward arrows that would have recommended covering of the stocks at that time. The percentage provided adjacent to the upward arrows represent the percentage of stocks that would have been recommended for cover at the price existing at that point of time. The inverted arrows represent the signal that would have recommended for short of the stocks at that time. The horizontal lines represent the stop loss price level.

### DETAILED DESCRIPTION OF THE INVENTION

This present invention provides an algorithm, an apparatus and a method for determining and displaying trading trends of stocks. The algorithm, the apparatus and the method of determining the trading trends according to the present invention can be used by anyone interested in investments such as individual investors or investment brokers. The present invention can be used to analyze market data related to trading of a particular financial instrument and develop trade information, particularly trading trends, which can be used to reduce the risk of loss for the investor. The trading trend is displayed in front of a trader on demand on a suitable web browser.

The apparatus of the present invention is a system of computers. The computers in this system of computer are interconnected. Web Server is the central computer in this system. The Web Server is communicably connected to a third party computer source providing end of the day trading information about specific stocks in defined markets. The Web Server computer receiving the market. data from the third party computer, analyzes the market data using an algorithm of the present invention, calculates the market trend and displays a visual indicator of market trend for one or more financial instruments in its website. The terminal user accesses the Web Server using a log in credentials and receives the trading trend and recommendations for trading as a visual display on his/her web browser.

In the disclosure made herein, the present invention has been exemplified only with reference to stock trading and more specifically the suitability of the algorithm of the present invention has been demonstrated for long trade (i.e., the purchase of securities). However, it should be realized here that the principles and applications disclosed herein can be applied to trading of a wide range of financial instruments. The apparatus and the method according to the present invention can be customized to display signals for buying and selling opportunities for other financial instruments including but not limited to bonds, commodities and foreign currency pairs without deviating from the scope and spirit of the present invention. Likewise, computer system and the algorithm of the present invention can be applied to multiple time frames and not restricted to the end of the day data used here for demonstrating the usefulness of the computer system and the algorithm. More specifically the computer system and the algorithm of the present invention can be customized for short trading as well.

The present invention analyzes market data and develops trade information for the purpose of reducing the risk of loss for the investors. More specifically, the apparatus according to the present invention provides a better enter/exit guidance during the trading of financial instruments than what a trader can obtain from a broker or form his/her own calculations of raw market data. In other words the algorithm based method and apparatus of the present invention guides the investors and investment brokers as to when to buy a stock or when to sell a stock.

The algorithm, the apparatus and the method of displaying trading trends of this present invention is useful for those who are interested in trading financial instruments. The present invention analyzes the trade data and provides the investor with trade trends, trade indicators and fundamental information about the particular financial instrument being traded. At a practical level, the present invention guides a trader with symbol and color coded displays on the web browser in front of the trader. For example, a green upright arrow in the computer terminal in front of the trader is used to indicate the recommendation to enter a trade. On the other hand, a red inverted arrow in the computer terminal in front of the trader is used to indicate the recommendation to exit a trade.

The present invention enables the trader to make better decisions about trading. By means of using the algorithm, apparatus and method of present invention, the trader receives recommendations either for entering a trade or exiting a trade at their home computer screen rather than relying on the information that might be provided by a broker or resorting to calculation of raw financial date. Thus by means of using the algorithm, apparatus and method of the present invention, the trader will be able to make better trade decisions because the present invention makes it easier to track the trade besides providing recommendations as to when to enter the trade or when to exit the trade.

As defined in the present invention, the term “frontend” means the computer terminal in front of the trader who is planning to execute the trade. The frontend may be monitor attached to a desk top computer, a lap top computer, a hand-held device such a tablet, including but not limited to iPad, a smart phone including but not limited to Phone, BlackBerry, and Android devices and any other electronic device which is able to receive electronic data from another computer and visually display the electronic data to the user.

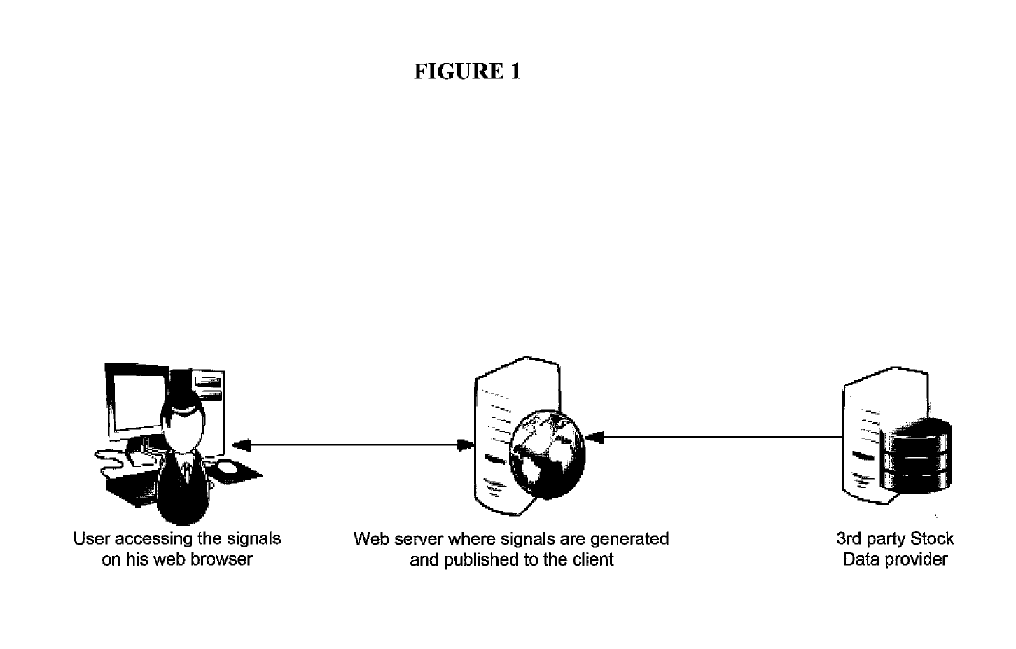

As defined in the present invention, the term “backend” means a computer which receives the market data from financial institutions and analyzes the market data using an algorithm. As illustrated in FIG. 1, the backend is a Web Server which receives the trade data from a third party computer and uses an algorithm to analyze the trade data and displays the trading trends along with the recommendation for trade at the web browser used by an investor or an investment broker.

The algorithm for analyzing the trade data can be embedded in the backend computer or it can be provided to the backend computer from yet another computer connected to the backend computer through a wireless or physical connection such as local area network connection. Alternately the computer providing the algorithm and the backend computer may be remotely connected through internet.

As defined in the present invention, the term “algorithm” is a step-by-step process for doing a particular calculation. More precisely, an algorithm is an effective method expressed as a finite list of well-defined instructions. Starting from an initial state and initial input, the instructions describe a computation that, when executed, will proceed through a finite number of well-defined successive states, eventually producing “output” and terminating at a final ending state.

Algorithm can be expressed in many kinds of notation, including natural languages, pseudocode flowcharts, programming languages, or control tables processed by interpreters. Natural language expressions of algorithms tend to be verbose and ambiguous, and are rarely used for complex or technical algorithms. Pseudocode, flowcharts and control tables are structured ways to express algorithms that avoid many of the ambiguities common in natural language statements. Programming languages are primarily intended for expressing algorithms in a form that can be executed by a computer, but are often used as a way to define or document algorithms.

In the context of a computer system, an algorithm is basically an instance of logic written in software by software developers to be effective in a specified computer in order for the target computer to produce a specified output from a given input.

As used in the present invention, the term software refers to one or more computer programs and data held in the storage of the computer for some purposes. In the context of a computer, the term software refers to a set of programs, procedures, algorithms and its documentation concerned with the operation of a data processing system. In short, the software tells a computer as to what to do and how to do it. Program software performs the function of the program it implements, either by directly providing instructions to the computer hardware or by serving as input to another piece of software.

In the present invention, the algorithms used to determine the trading trend and recommendations for a particular financial instrument from prior market data can be expressed in one or other computer-readable programming language and such an algorithm expressed in a computer-readable programming language would be qualified as computer-readable software. As defined in the present invention, the term “trading software” refers to an algorithm useful in determining the trading rend of a financial instrument based on prior market data for the purpose of determining the time point at which to enter into the trade or the time point at which to exit the trade and written in a computer-readable programming language.

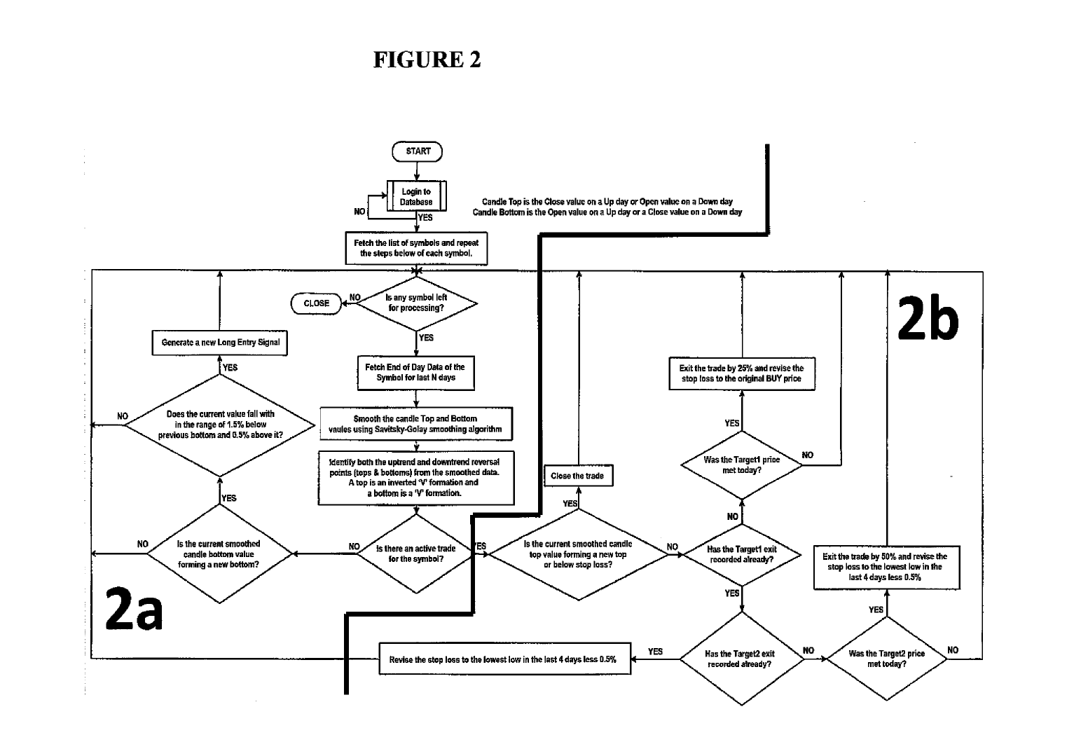

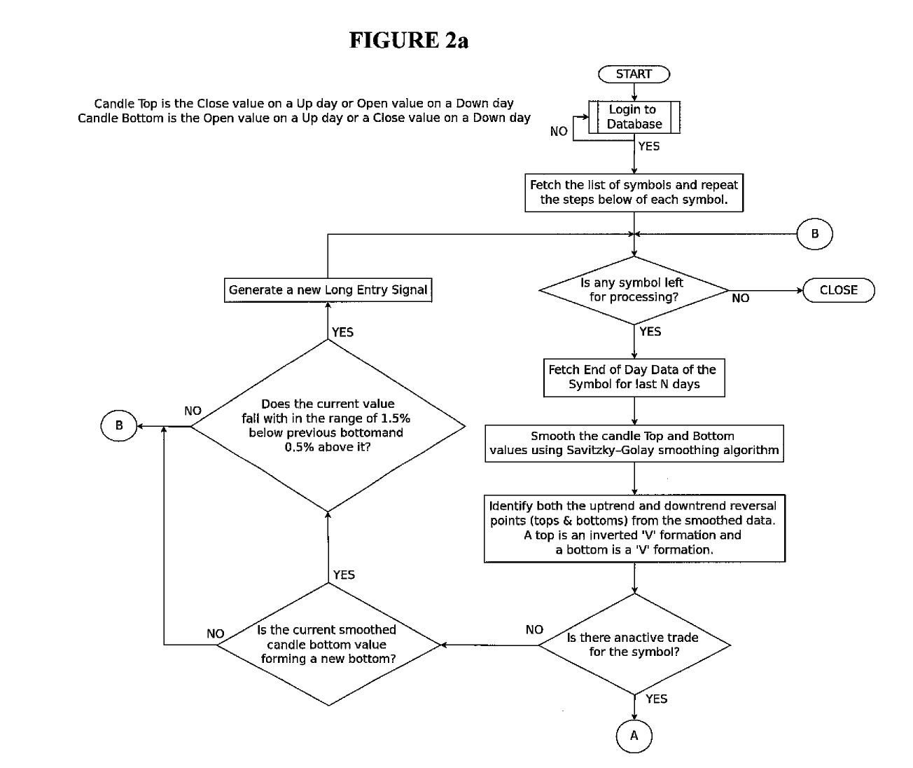

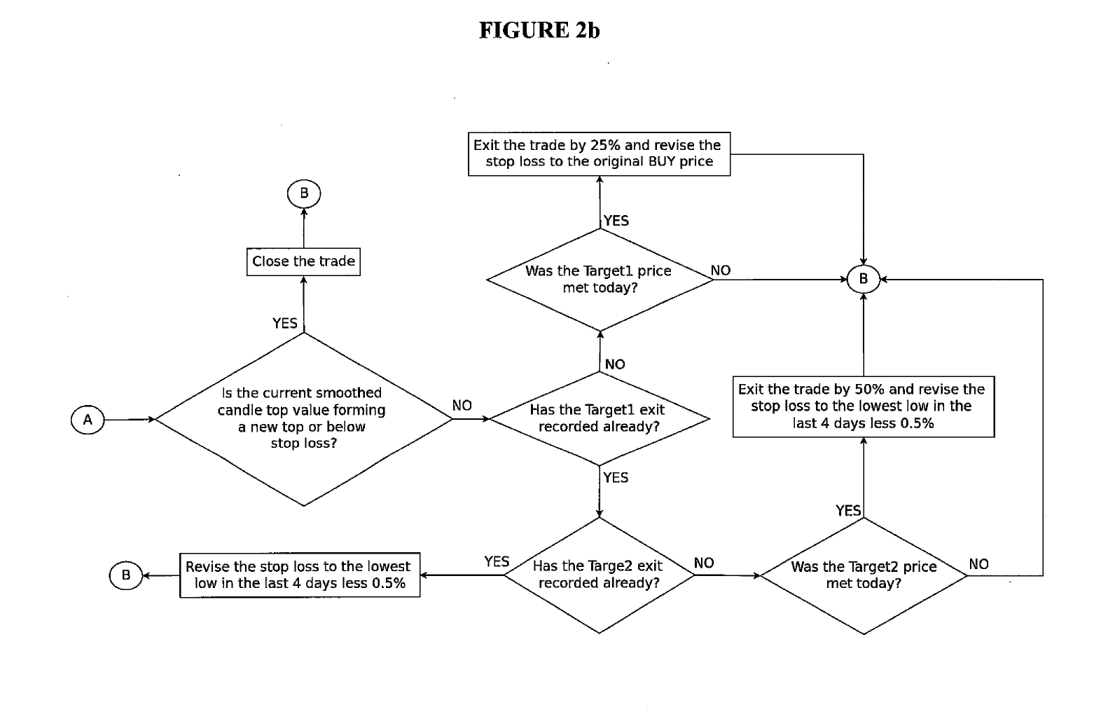

The present patent disclosure expresses the algorithm for determining the trading trend for a particular financial instrument using prior market date for the purpose of making recommendations as to whether to enter a trade or to exit a trade in the form of pseudocode flowchart as illustrated in the FIG. 2. An individual skilled in the art of software development would be able to transform the flowchart information provided in this patent application into trading software using one or other programming languages well-known in the field of computer sciences and would be able to practice this present invention without any undue experimentation.

As used in the present invention, the term “enter the trade” means the trader is investing money by buying a particular financial instrument for cash in an openly traded and authorized exchange.

As used in the present invention, the term “exit the trade” means the trader is selling the financial instrument in his possession for cash in an openly traded and authorized exchange.

As used in the present invention, the term “preset parameters” refers to the boundary values for a particular financial instrument. The decision to enter the trade or to exit the trade is made on the basis of the current value of the financial instrument with reference to the preset parameters. If the value of a particular financial instrument is rising above a preset parameter, for example the monetary value of that particular financial instrument, a recommendation is made to exit the trade and cash in the profit from trading at the peak market value. On the other hand, if the current value of a particular financial instrument is sliding, a recommendation is made to exit the trade at the bottom of the preset parameters so that further loss associated with that particular financial instrument is avoided.

As used in this invention, the term “stop-loss” refers to a preset value minimum risk that investor is ready to take. Based on the preset value for minimum risk for a particular stock in terms of a dollar value, the algorithm of the present invention displays a horizontal line in the web browser at the frontend. The trader is expected to sell the stock when the stock value goes below the stop-loss line.

In the present invention, step-by-step process is provided to calculate the trading trend for a particular financial instrument using prior market data and to determine the time points to enter the trade or the time point to exit the trade. The algorithm of the present invention provides a finite list of well-defined instructions for calculating the trading trend starting with prior market data.

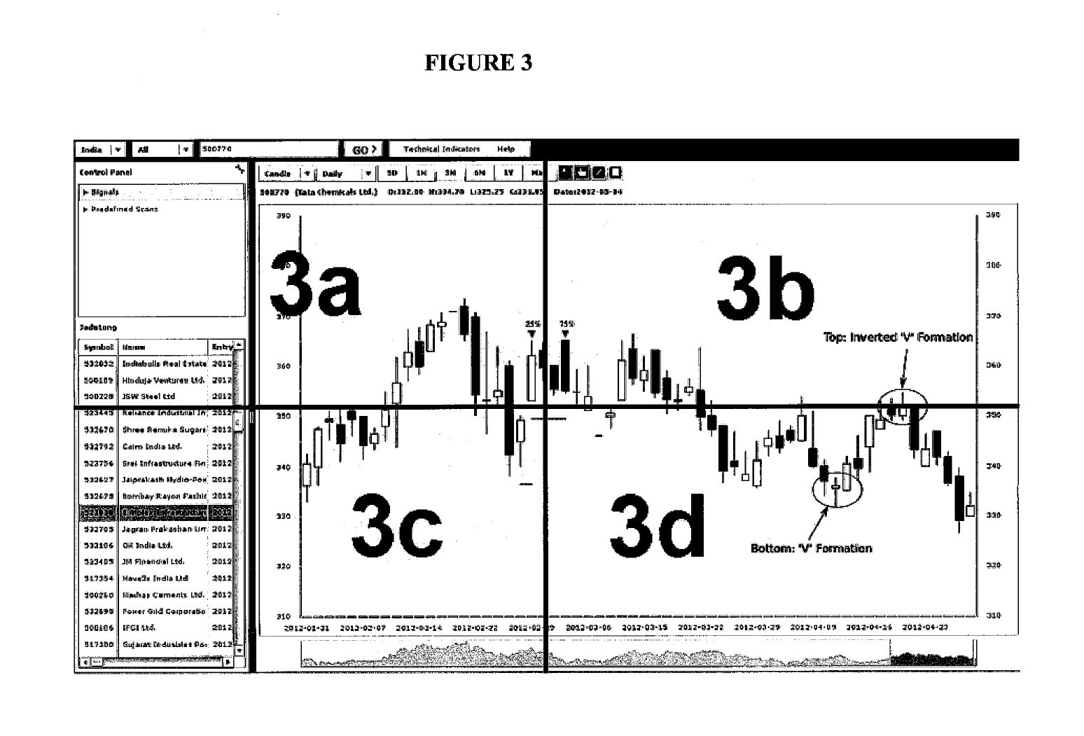

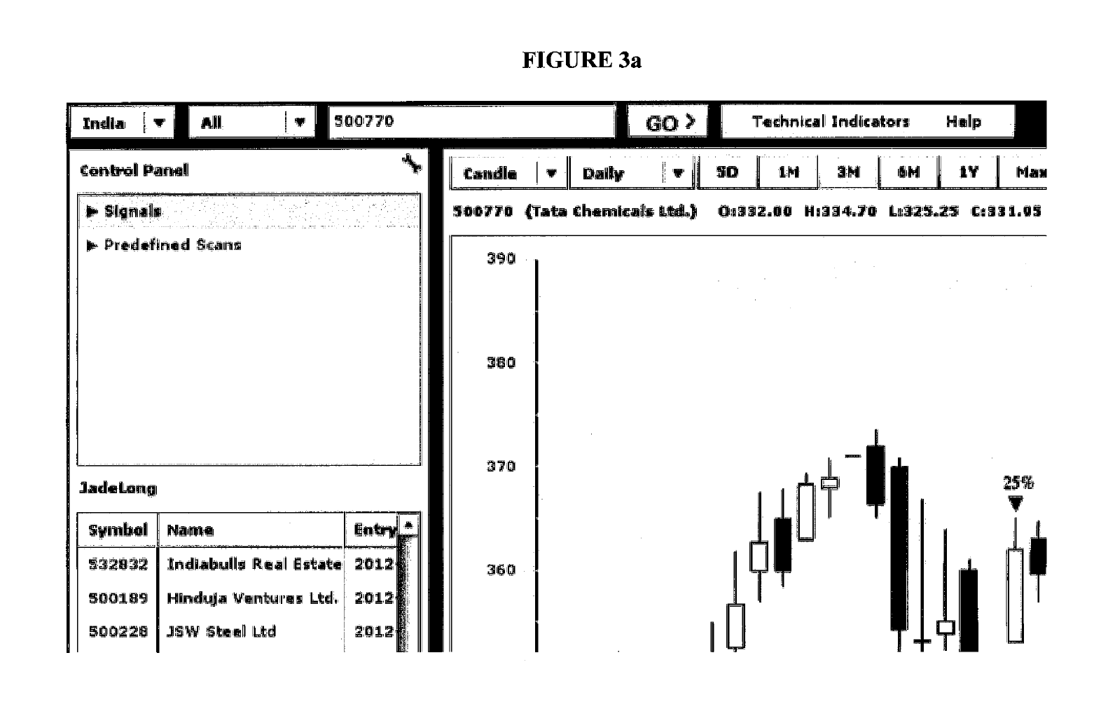

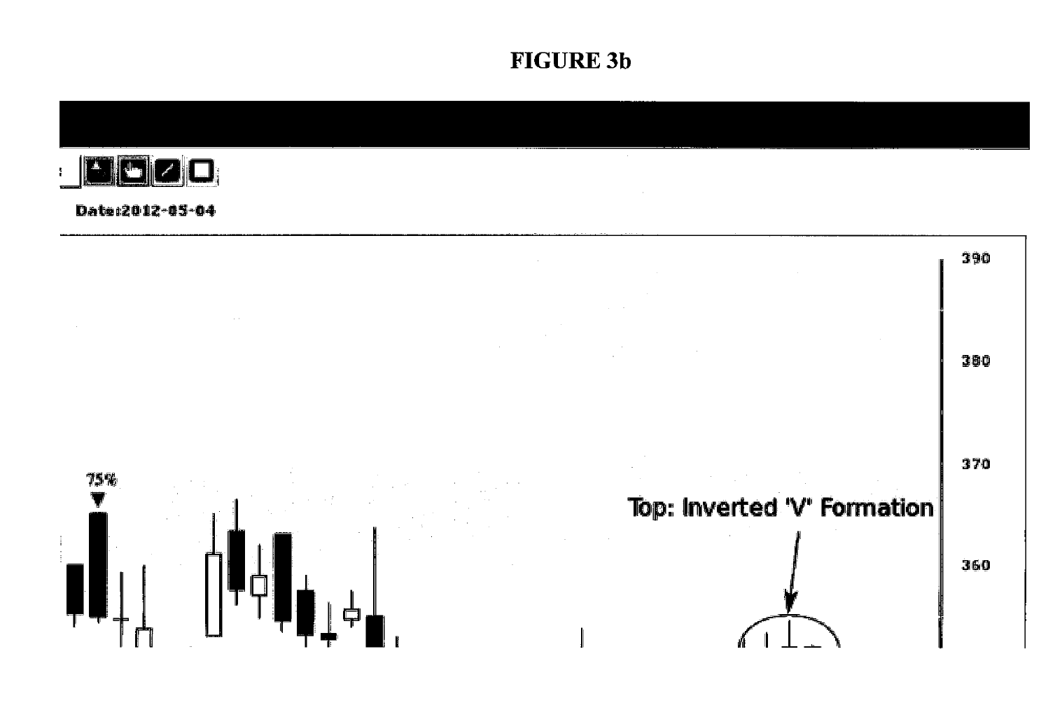

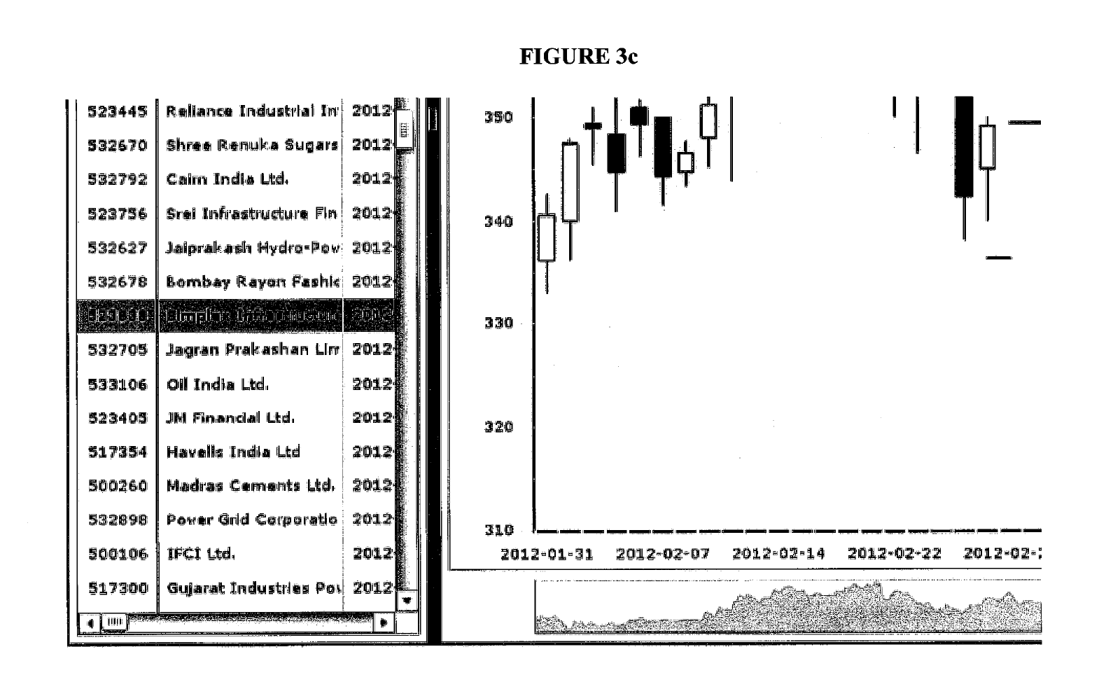

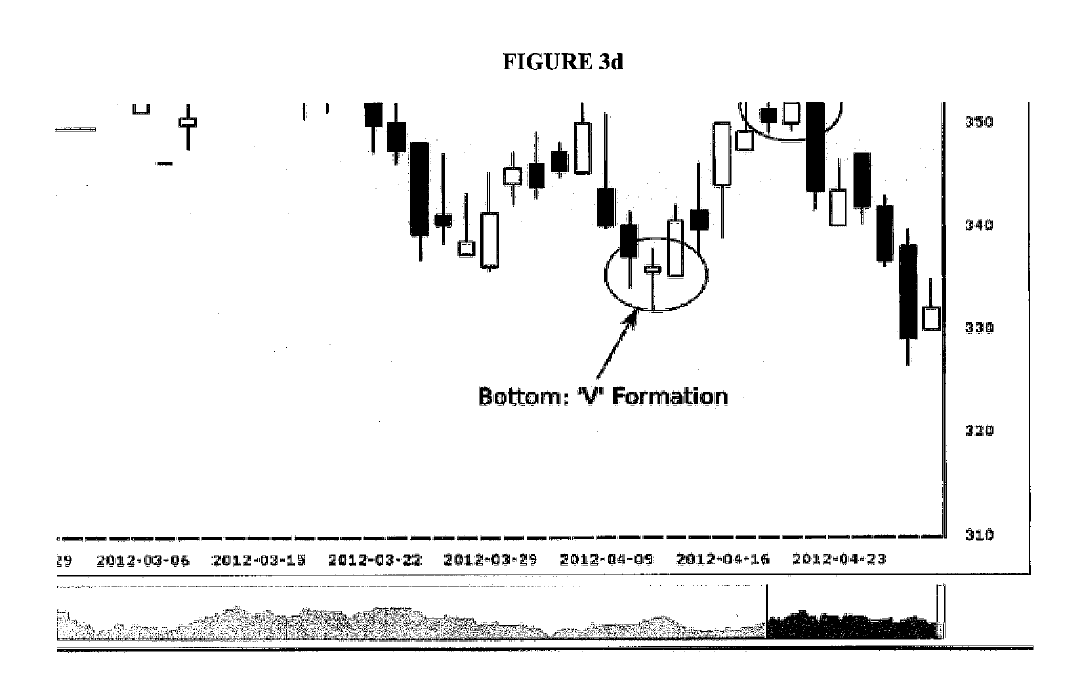

FIG. 2 provides the flowchart for the algorithm of the present invention. After logging into a registered account at the Web Server, the trader selects a particular stock using the symbol or the name for that stock. The algorithm embedded in the Web Server fetches the end of the day data for that particular stock from third party provider and smoothens the candle top and bottom values using Savitzky-Golay smoothing algorithm. Candle “top” is the close value on an up day (the day when the stock is moving upward) or open value on a down day. Candle bottom is the open value on an up day or a close value on a down day. From this smoothed data, the algorithm identifies the uptrend and downtrend reversal points, the top and bottom values for the stock. The top value is an “inverted v” formation and the bottom value is a “V” formation. The “inverted V” formation and “v” formation are recognized from the head and shoulder pattern in the chart as illustrated in FIG. 3.

Once the uptrend and downtrend reversal points are determined, the question is asked whether there is an active trade for that particular stock. If there is no active trade for that particular stock, a determination is made as to whether the current smoothed candle bottom value is forming a new bottom. If the answer to this question is “YES” the system asks the next question as to whether the current value falls within the range of 1.5% below previous bottom and 0.5% above it. If the answer to this question is “YES”, the system generates a new long entry signal. Long entry signal represents the value of the stock at which a recommendation is made to buy the stock.

After the system has identified the uptrend and downtrend reversal points from the smoothed data, if there is an active trade for that stock at the time, the question is asked whether the current smoothed candle top value is forming a new top or is it below stop loss. If the answer is “YES”, recommendation is made to close the trade. Closing the trade means to sell all the remaining shares of the stock. If the answer to this question is “NO”, the next question is asked as to whether the Target 1 exit has already been recorded. If the answer to this question is “NO”, then the next question is asked as to whether the Target 1 price is met for that day. If the Target 1 price was met that day, recommendation is made to exit the trade by selling 25% of the stocks held and to revise the stop loss to the original Buy price. If the answer to the question above is “NO”, then there is no significant activity in the stock and no instruction is made for that stock for that day.

On the other hand, when the answer to the question whether the Target 1 exit has already recorded is “yes”, the next question is asked whether the Target 2 exit has already recorded. If the answer to this question is “NO”, the next question is asked as to whether the Target 2 price was met for that day. If the answer is “YES”, recommendation is made to exit the trade by selling 50% of the stock held and the stop loss is revised to the lowest low in the last four days less 0.5%. If the answer to the question above is “NO”, then there is no significant activity in the stock and no recommendation is made for that stock for that day. On the other hand, if the answer to the question as to whether Target 2 exit. has already recorded is “YES”, then the stop loss is revised to the lowest low in the last 4 days less 0.5%.

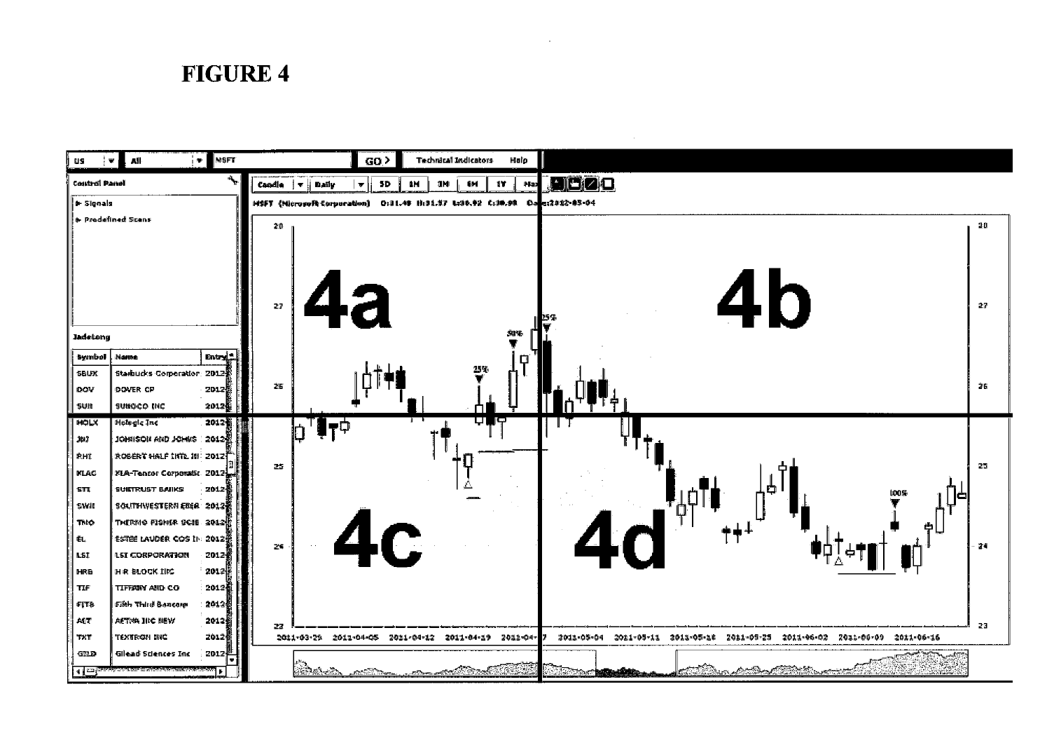

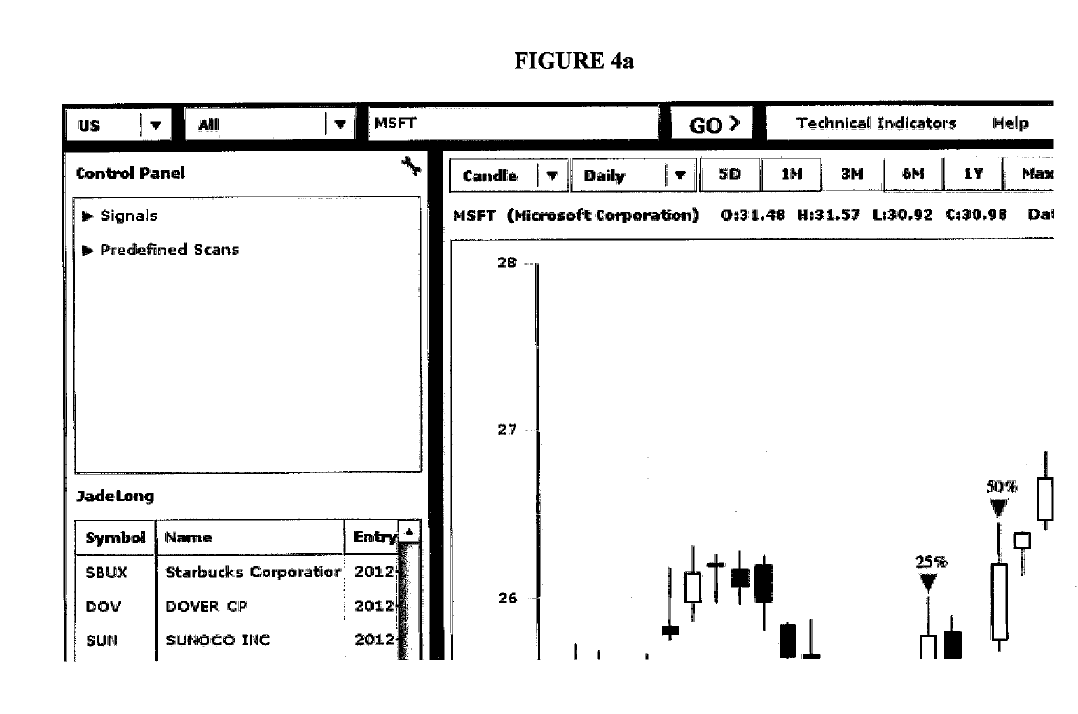

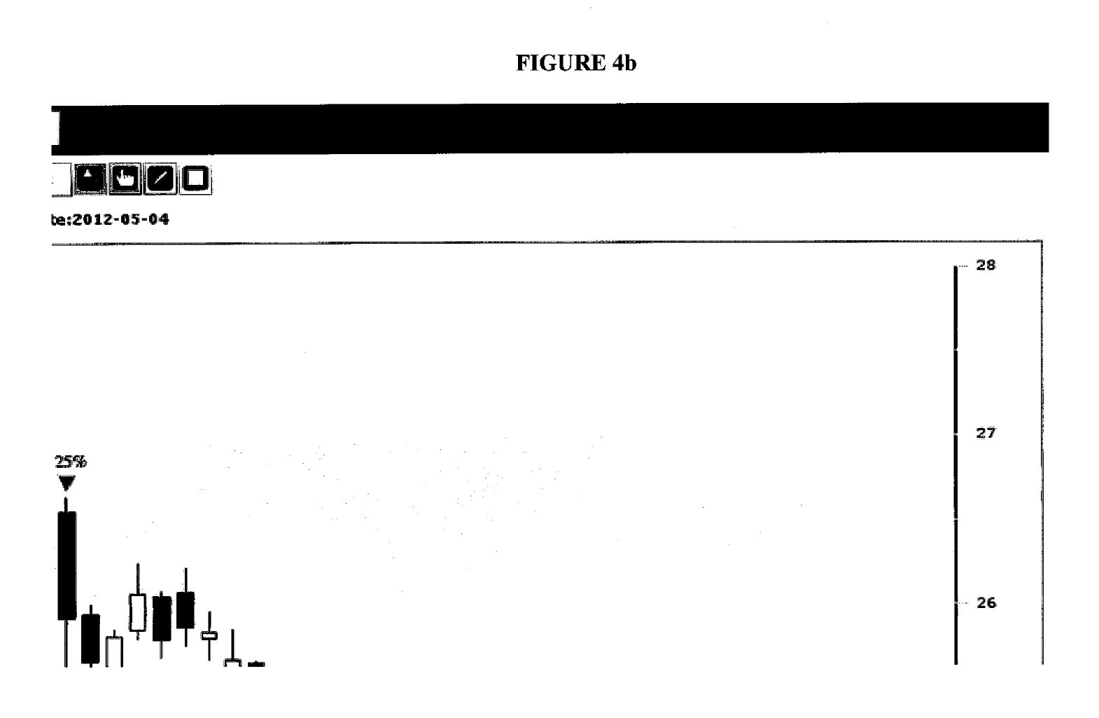

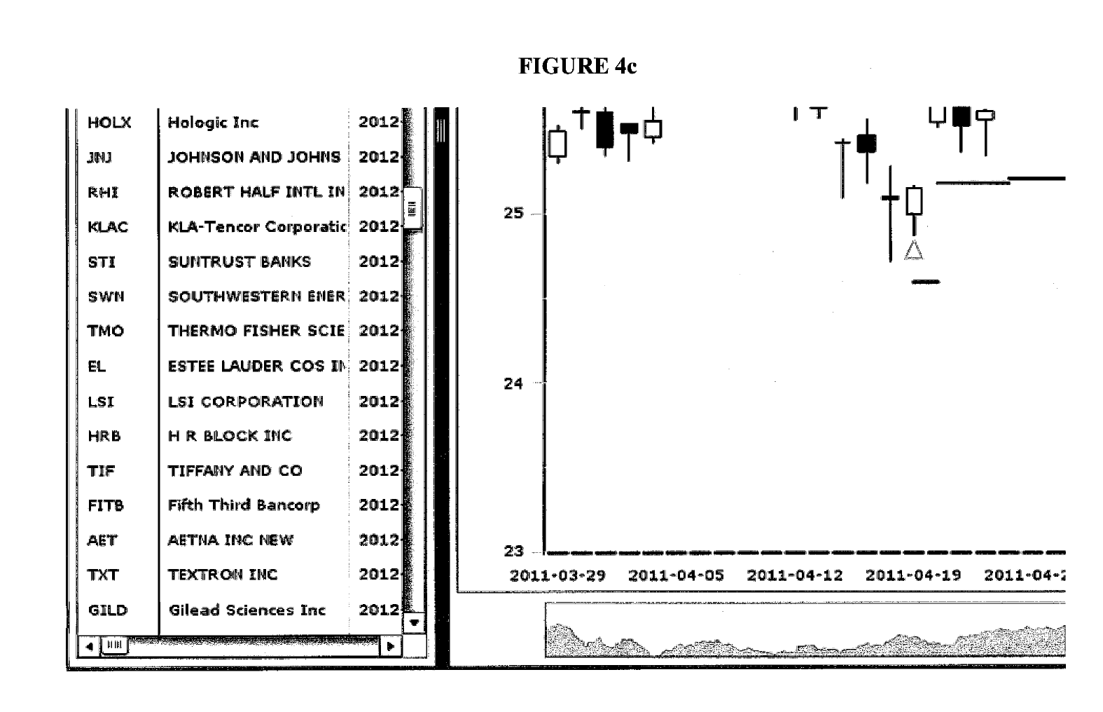

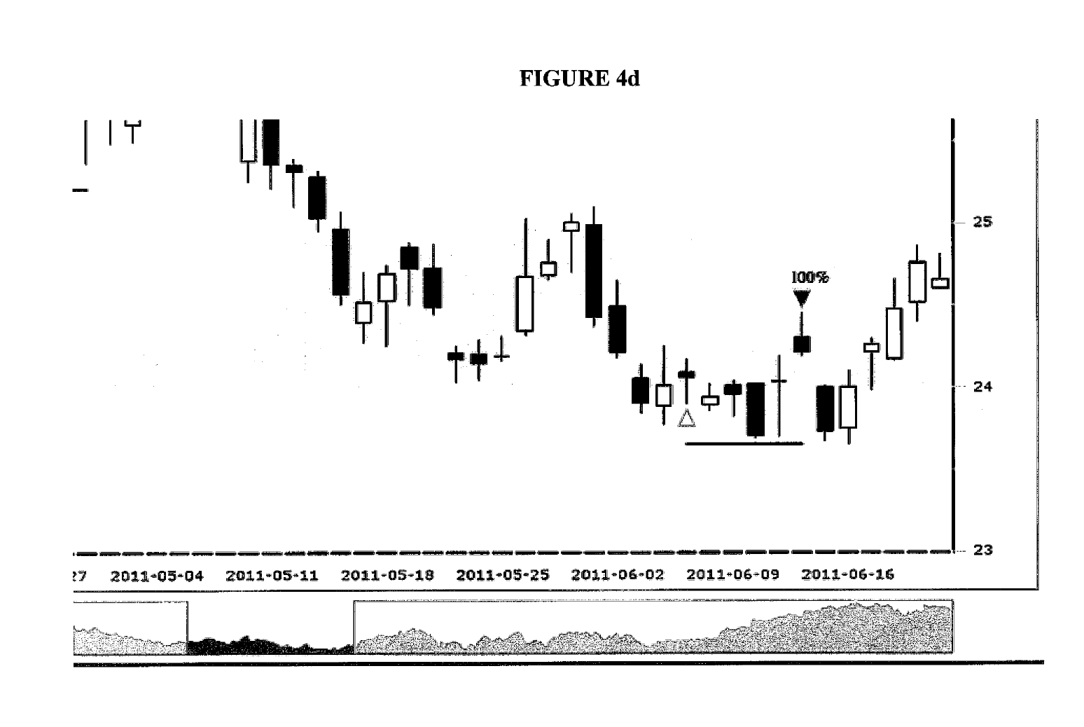

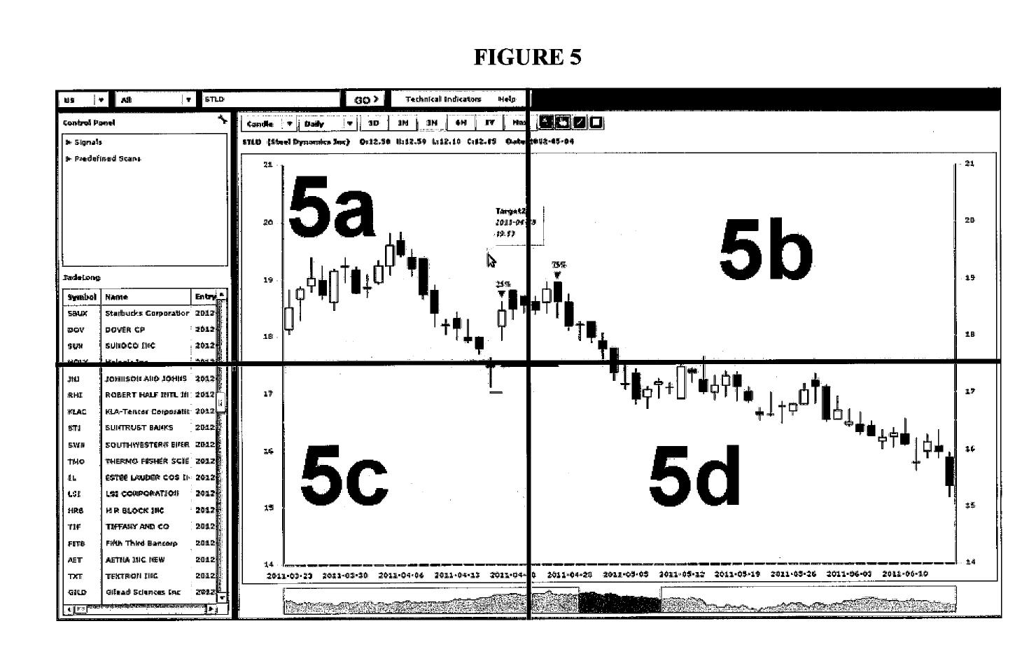

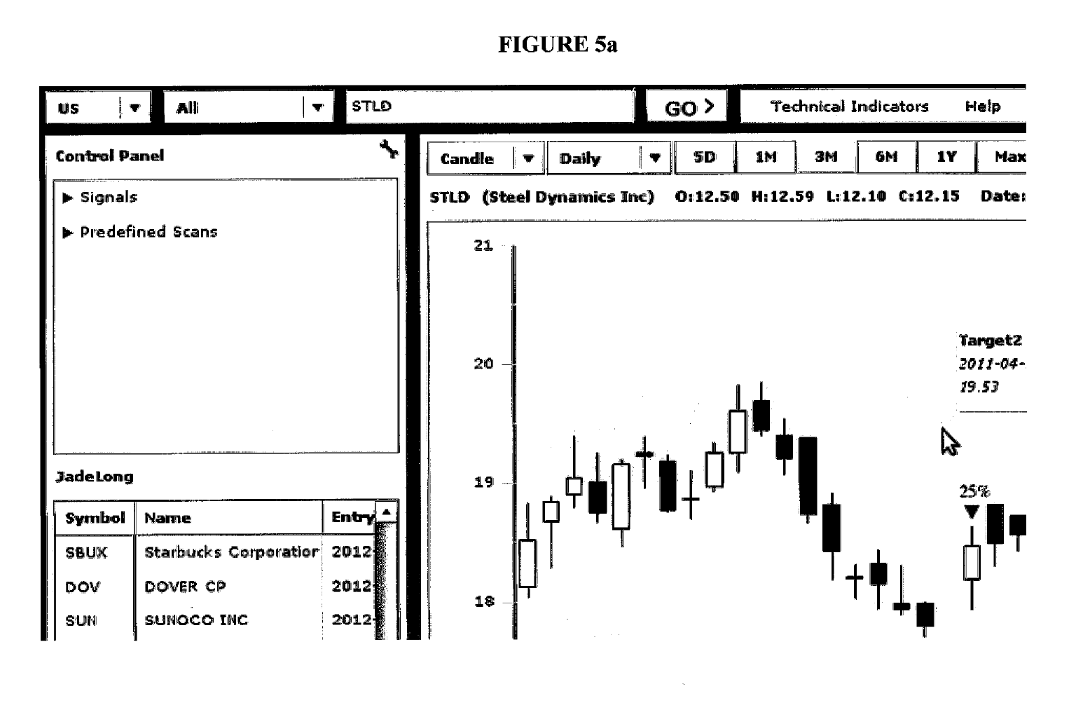

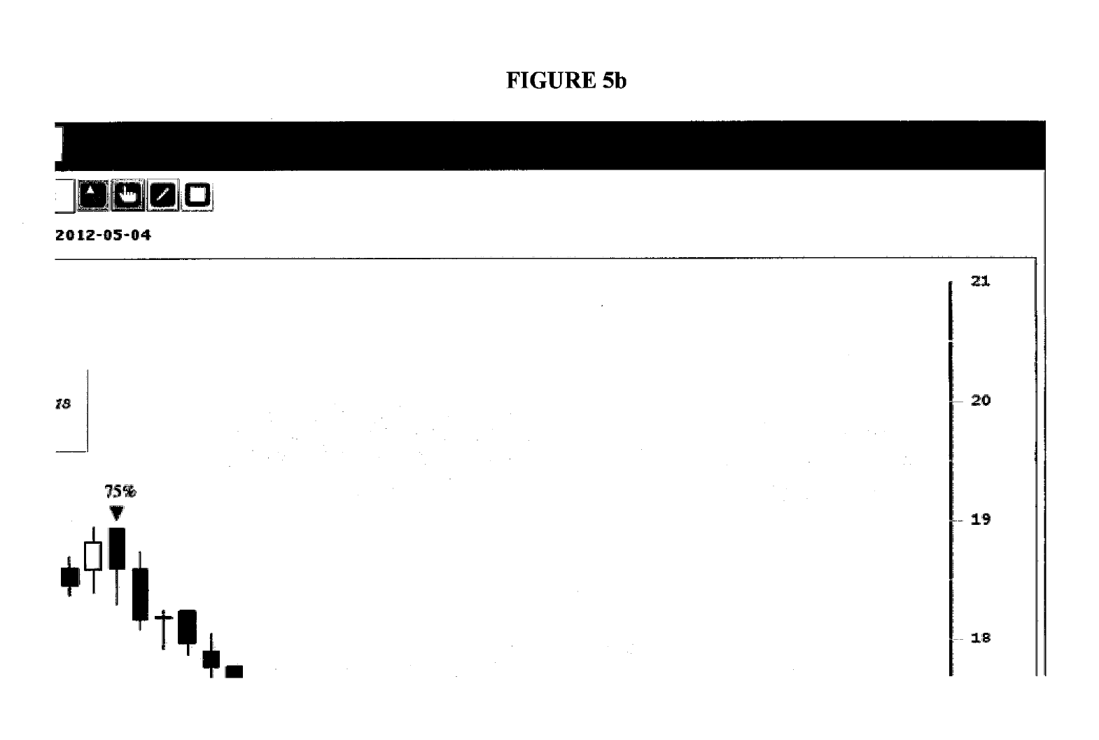

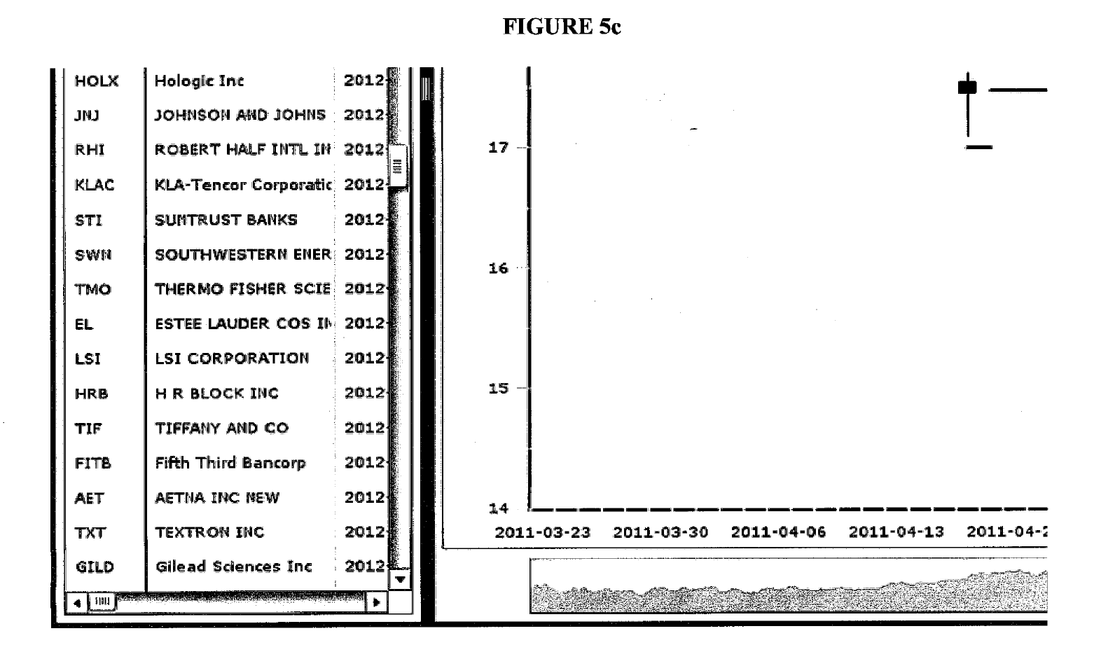

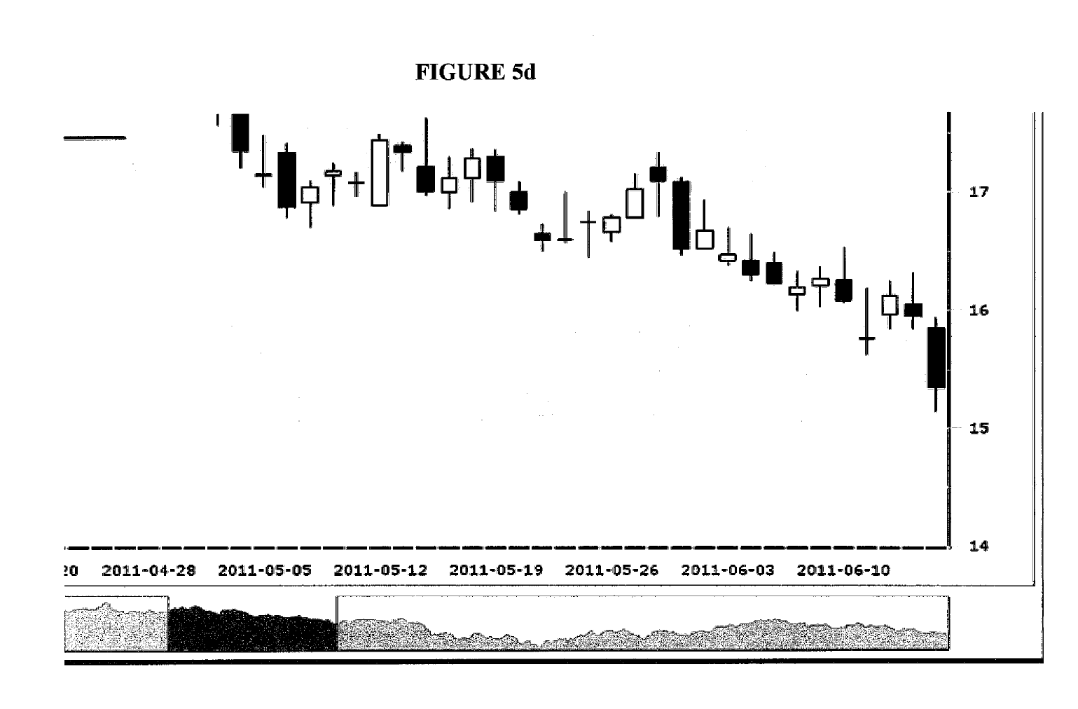

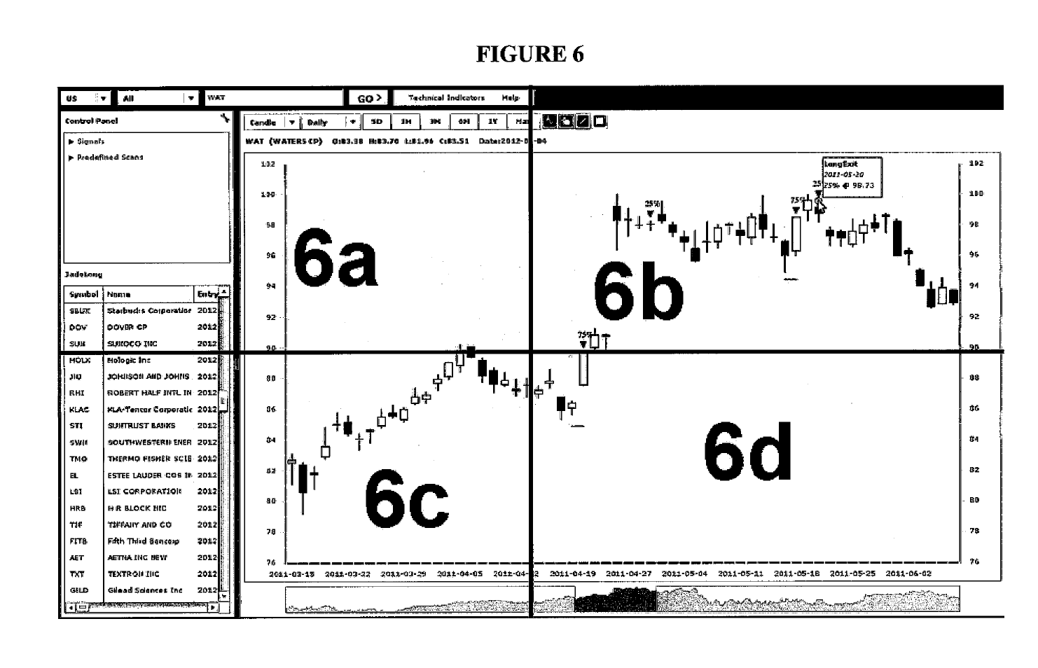

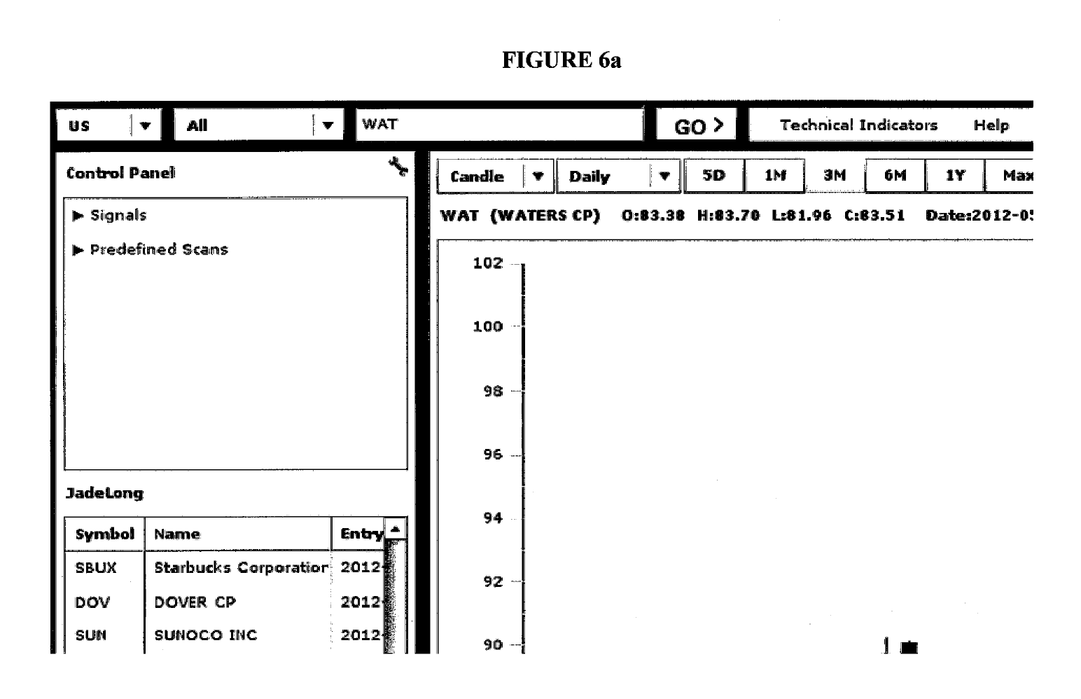

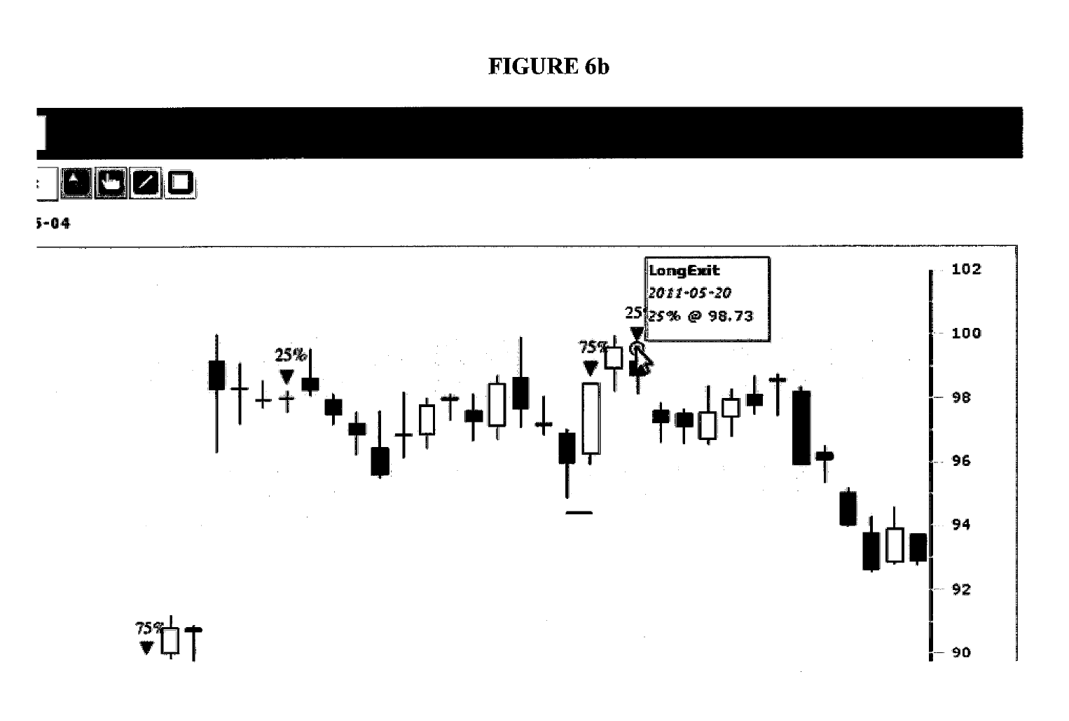

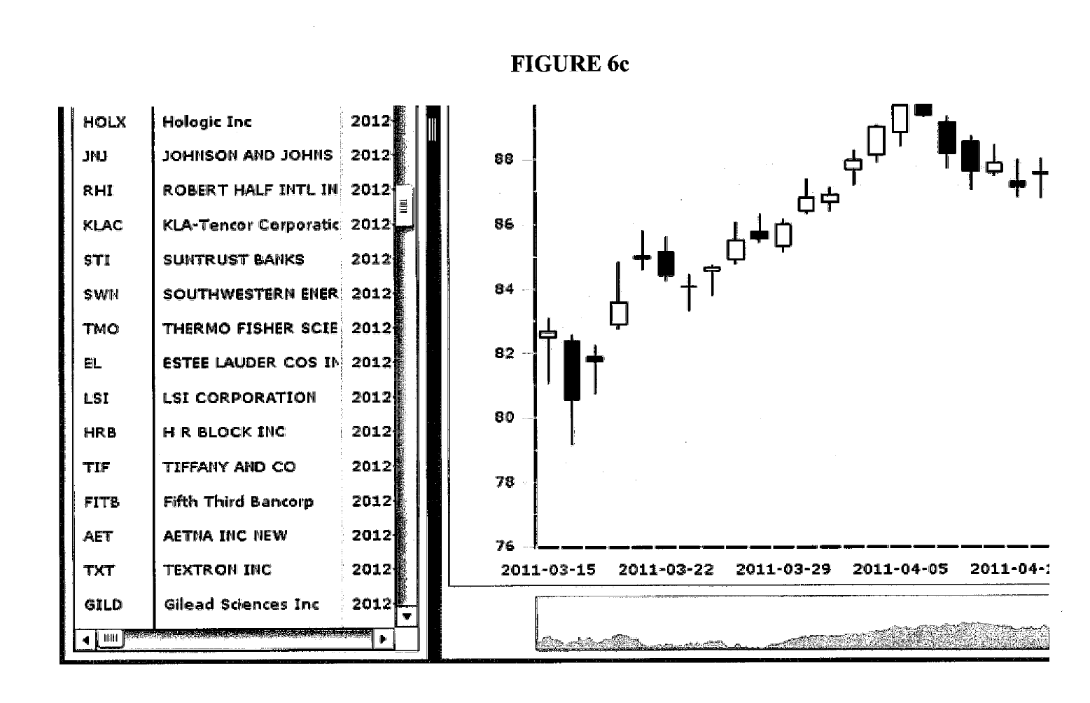

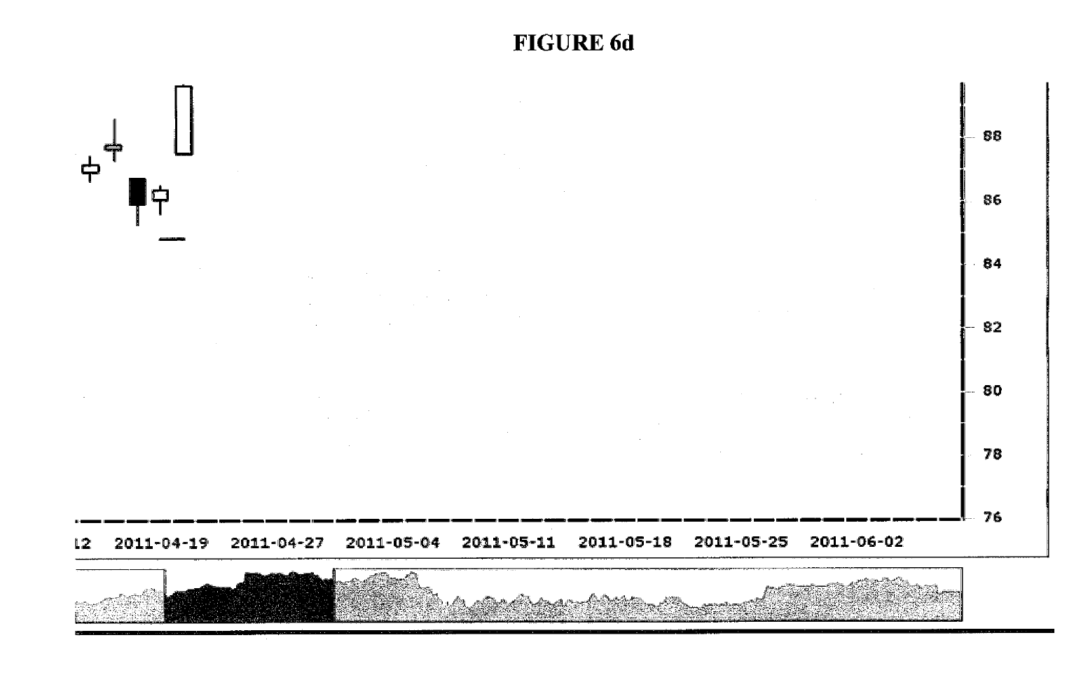

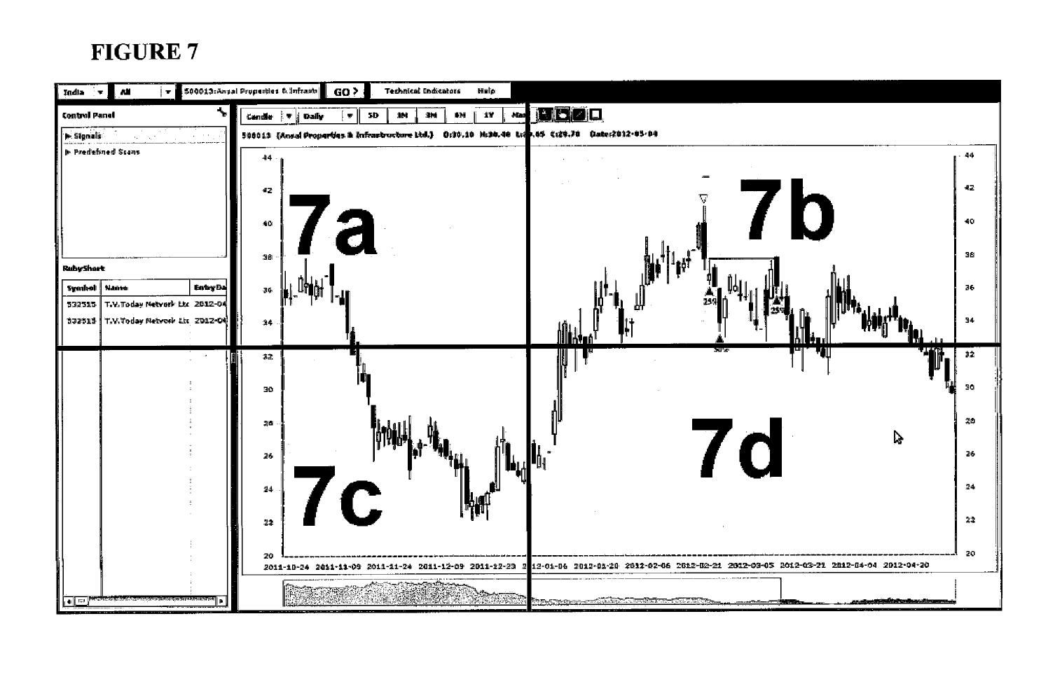

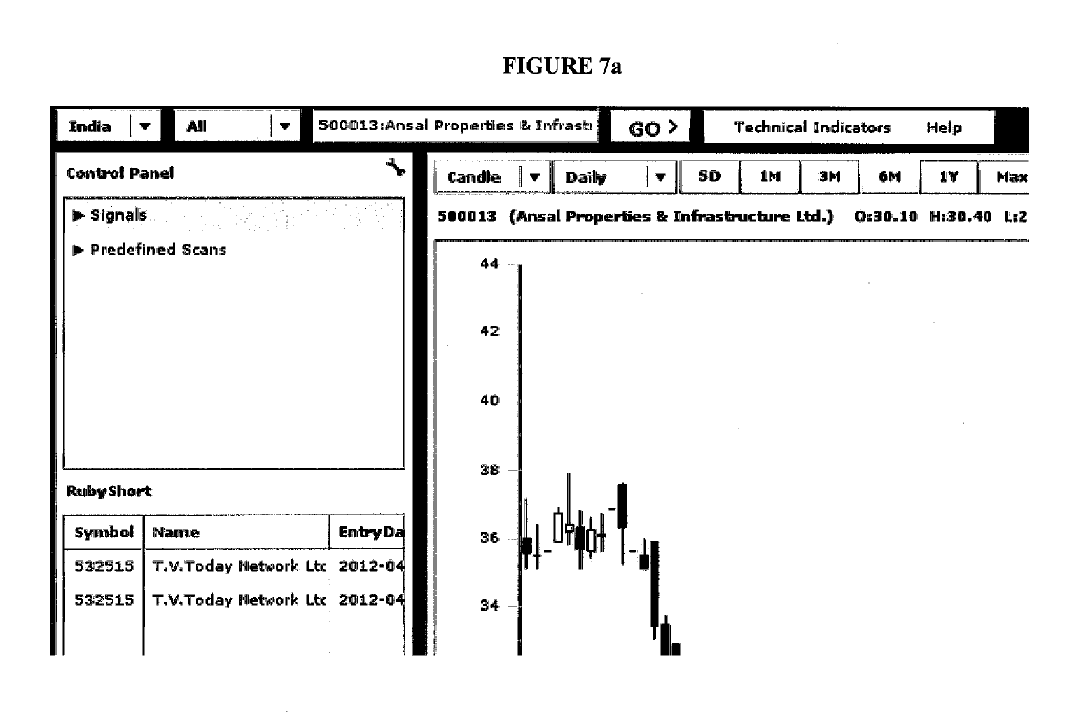

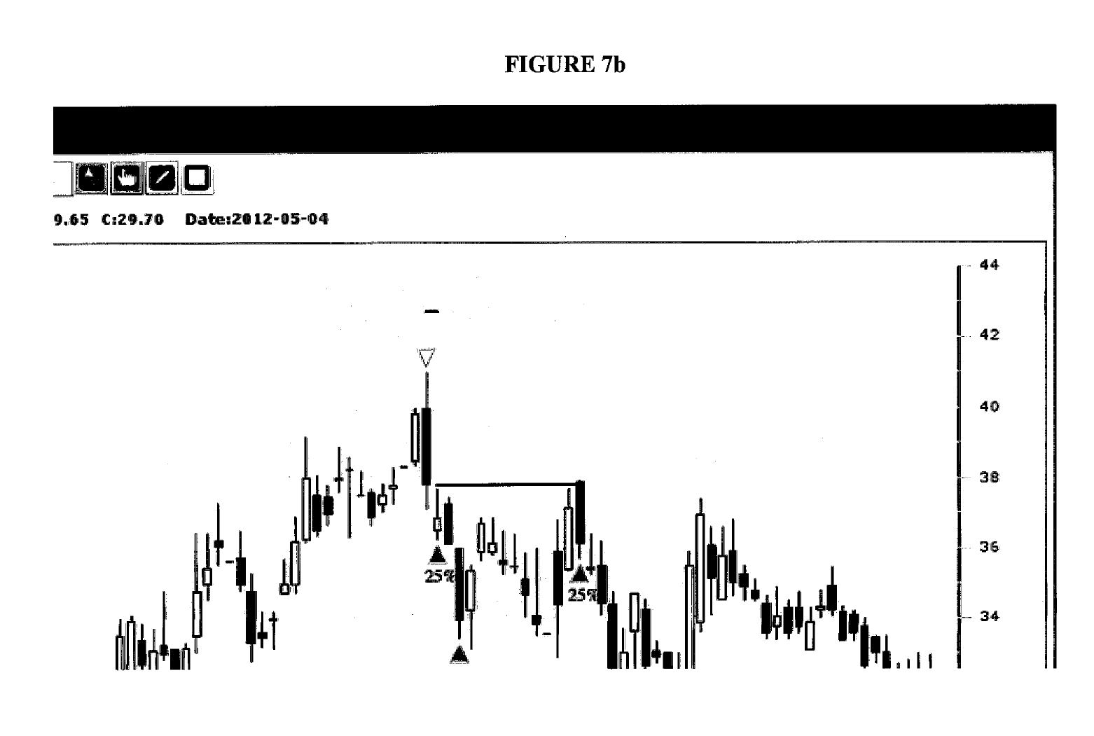

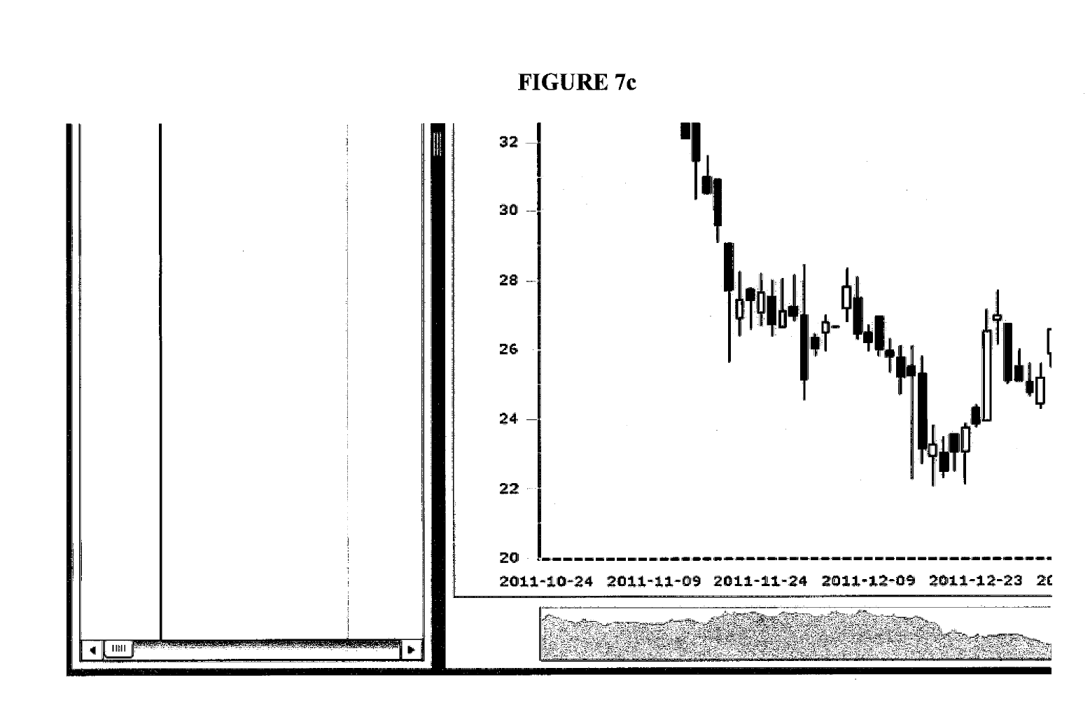

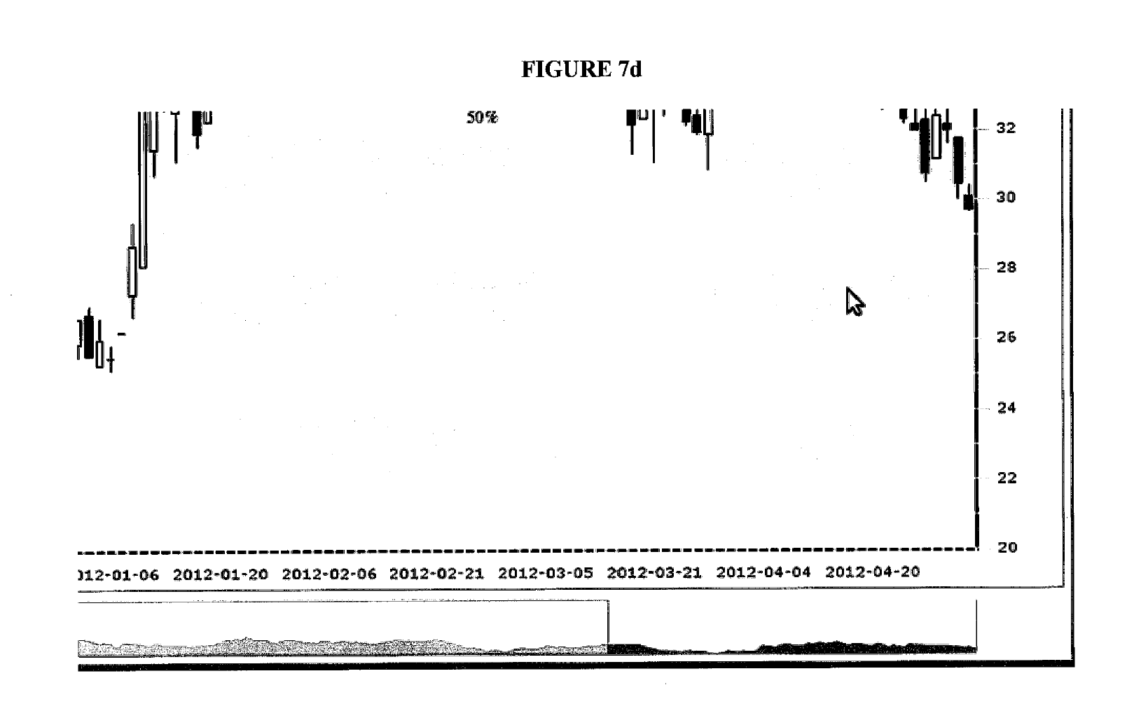

FIGS. 3 through 7 provided herein explain the application of the algorithm of the present invention along with the apparatus and the method of the present invention. The data in the FIGS. 3 through 7 are provided only for the purpose of demonstrating the application of the present invention in stock trading and in no way limit the scope of the present invention. The other features and advantages of the present invention will be apparent to those of ordinary skill in the art upon reference to the following detailed description taken in conjunction with the accompanying drawings.

A trader interested in using the trading information provided by the present invention can access the required market information via internet web site, dial-up and other network connection to view the trading trend for a particular financial instrument. Based on the trading chart developed using the algorithm of present invention and displayed at the computer terminal in front of the trader, a decision can be made as to enter into a trade or to exit a trade. The algorithm of the present invention obtains trade data from the markets and updates the data being displayed on the computer terminal in front of the trader so that the trader has the latest trading trend to make an informed decision. Moreover, the algorithm provides recommendations as to when to enter a trade and/or when to exit a trade.

This present invention will help the traders, particularly the swing traders to manage their trades better and make profits on a consistent basis. The present invention is based on the algorithm used in our backend system to analyze end of day market data on individual stocks and make recommendation on trade. The point to be kept in mind is that the backend algorithm could change depending upon the relevant technical indicators used for various types of trades and suiting different market conditions.

The salient features of the charting tool are: (1) Displays buy/sell recommendations for stocks based on signals generated automatically by backend algorithms; (2) Displays visually the stop loss when entering a trade and moves the stop loss as the user stays in trade; (3) Displays multiple exits depending upon pre-determined threshold crossing, to lock in profits and updates the stop loss dynamically; (4) Gives pre-defined scans to users to identify stocks meeting certain criteria for a given market; and (5) Displays visually the targets.

The invention is about providing the trade recommendations and helping the customers/users manage the trade using our multiple exit recommendations to lock in profits. The trades are made profitable by exiting in portions (as provided in percentages) and trailing the stop loss thus locking profits. For example, if we give a BUY recommendation for a stock on Day A, and on Day B we notice that a reasonable profit is achieved, we recommend the customer/user to exit a portion of the trade, say 25% of stocks held. Then on Day C, we notice that some more reasonable profit is made, we recommend another portion of exit (say 50% of stocks held). After this the rest of the stocks will be sold when the SELL criteria is met. We also trail stop loss while the trade is active which is shown visually in the tool as horizontal bar in the graphic display of the stock performance. Note that all of this is automatically handled in our trading system without manual intervention. Thus reducing risk and locking in the profit is the primary goal of the signals derived using the algorithm of the present invention.

The present invention can also be extended to an automated trading. In the electronic financial markets, automated trading also known as algorithmic trading or alga trading or black-box trading or robe trading is the use of computer programs for entering trading orders with the computer algorithm deciding on aspects of the order such as the timing, price, or quantity of the order, or in many cases initiating the order without human intervention.

The graphic display at frontend system may be a simple standard O.H.L.C (open, high, low, close) bar chart or preferably a candlestick chart. A candlestick chart is a style of bar-chart used primarily to describe price movements of security, derivatives, or currency over time. It is a combination of line-chart and a bar chart, in that each bar represents the range of price movement over a given time interval. It is most often used in technical analysis of equity and currency price patterns. They appear superficially similar to error-bars but are unrelated. Candlesticks are usually composed of the body (black or white), and an upper and a lower wicks. The area between the open and the close is called the real body. Price excursions above and below the real body are called shadows. The wick illustrates the highest and lowest traded prices of a security during the time interval represented. The body illustrates the opening and closing trades. If the security closed higher than it opened, the body is white or unfilled, with the opening price at the bottom of the body and the closing price at the top. If the security closed lower than it opened, the body is black, with the opening price at the top and the closing price at the bottom. A candlestick need not have either a body or a wick. To better highlight price movements, modern candlestick charts (especially those displayed digitally) often replace the black or white of the candlestick body with colors such as red (for a lower closing) and blue or green (for a higher closing). Time period most commonly represented are for trading days but they can be for any period such as a week or month.

In addition to revealing the opening, closing, high, and low prices for the period the bar chart tells us the range of price movement and whether the price was up or down for the period. By comparing the several bars in a series we can determine price trends, price volatility, and any developing price patterns. Normally a second set of verticals bars are located below the price graph to indicate sales volume with taller bars representing higher volume.

Embedded in the candlestick bar chart displayed at the front end system are the signals with the recommendation for trade. In the present invention, an inverted triangle represents a sell signal and an upright triangle represents a buy signal. A horizontal line represents a trailing stop loss. In the web browser at the frontend, the inverted triangle may be colored red and the upright triangle may be colored green. The horizontal line representing a trailing stop loss may be colored blue. A green dot in the chart displayed in the frontend represents the target.

Architecturally, the trading system for avoiding risk and preventing loss in the swing trading comprises a frontend system and a backend system connected through a communication channel. The frontend system may be represented by a computer terminal at a trader's location. The communication channel may be represented by a network, preferably internet. The backend system is represented by the server maintained by the service provider.

Embedded in the backend system is a means for receiving the market data from the market participants. The market participants may be represented by the entities managing the trading of the financial instruments such as securities and currencies. The input data may be obtained from securities exchanges, commodity exchanges, electronic communication network, data feed providers, brokerage firms, and qualified market participant. The list of representative market participants includes NASDAQ, DJI, and S&P500.

The market data includes the details about the trade elements such as maximum and minimum selling price, maximum and minimum buying price, volume traded, and volatility. In a preferred embodiment, the backend system receives end of day market data from the market participants. Embedded in the backend system is an algorithm that is used in the processing of the end of day market data received form market participants. In processing the end of day market date, the algorithm makes use of end of the day trade data and comes out with recommendation for trade with reference to the price of the trade element.

The recommendations for trade generated at the backend system are transferred to the frontend system as signals for selling or buying the trade element. The objective of the signals coming out of the backend system is to ensure that the risk in trading is reduced and the profit is maximized.

In another embodiment of the present invention, the algorithm may be housed in the frontend system and all the operations of the trading system is performed at the frontend system.

The signals for sell and buy recommendations are derived at the backend system using an algorithm. At the backend system, the market data received from the market participants is processed and two targets are decided. The first target (T1) is lower of stop loss equivalent move or the first resistance point. The second target (T2) is the higher of the two. Recommendation is provided to exit 25% at T1 and 50% at T2 and the remaining 25% is left until a reversal. The algorithm of the present invention also generates trail stop,

FIGS. 3 to 7 provides the graphical display the performance of five different stocks in the web browser at the front end used by the trader. Given below is a detailed description of various elements displayed in the graphical display in front of the trader. By means of using the buttons for the drop down menus at the top left hand corner, the trader has the option of selecting a particular nation in the world and a particular stock among a group of stocks. For example, by clicking the first drop down menu the trader can select to trade the stocks either in United States or in India. By using the second drop down menu on the right side of the first drop menu, the trader can choose to display the stocks listed either under Dow Jones Index (DJI) or NASDAQ 100 or S&P 500 for which the end of the day signal with recommendations for buying or selling has been generated using the algorithm of the present invention. The trader also has the option to display the combined list of all the stocks in DJI, NASDAQ 100 and S&P 500 for which the end of the day signal with recommendations for buying or selling has been generated using the algorithm of the present invention.

The list of the stocks for which the end of the day signal with recommendation for buying or selling has been generated using the algorithm of the present invention are displayed as a list in the box at the lower left corner of the graphical display. By clicking any one the stocks listed in this box, the trader can bring up the display of the stock chart in the box on the right side along with recommendations for entering or exiting the trade.

By means of selecting one or other buttons on the top of the box displaying the stock chart, it is possible to select the stock chart display for specific period, such as previous five days, previous one month, previous three months, previous six months, previous one year or maximum period of time for which the trade data is available for that particular stock. By means of using a drop down menu, the stock chart can be displayed on the basis of daily data or on the basis of weekly data. By using yet another drop down menu, the stock chart can be displayed in the form of candle, line or OHLC display.

By means of typing the symbol or the name of a particular stock in the third box from the left on the top row and clicking the button labeled “GO” it is possible to display the stock chart for that particular stock.

The graphical display at the frontend also built-in provisions for displaying various technical indicators such as Average Directional Index (ADX), Bollinger Bands, Commodity Channel Index (CCI), Exponential moving average (EMA), Fast Stochastic, MACD, Money Flow Index, Parabolic SAR, Rate of Change (ROC), Relative Strength Index (RSI), Savitzky-Golay Filter and Simple Moving Average (SMA). By means of using a drop menu, it is possible to display any one of these trade indicators.

What is claimed is:

1. A computerized trading system for determining and displaying the trading trends and useful in minimizing risk in trading comprising:
a. a frontend computer device with graphical display;
b. a backend Web Server, wherein said front end computer device is connected to the backend Web Server;
c. wherein said backend Web Server is set up to receive market data for financial instruments from a plurality of market participants;
d. wherein said backend Web Server analyzes said market data using an algorithm and creates a trading chart with signals that provide recommendation for security trade; and
e. wherein a trader using said frontend computer device with graphical display receives said trading chart with recommendation for security trade from backend Web Server on demand and uses it in executing a trade.

2. The computerized trading system of claim 1, wherein said signals that provide recommendation for security trade are signals that recommend buying a particular security.

3. The computerized trading system of claim 1, wherein said signals that provide recommendation for security trade are signals that recommend selling a particular security.

4. The computerized trading system of claim 3, wherein said signals that recommend selling a particular security specify a percentage of the security to be sold.

5. The computerized trading system of claim 1, wherein said signals that provide recommendation for security trade are signals that recommend buying or selling a particular security.

6. The computerized trading system of claim 1, wherein said frontend computer device with graphical display and said backend Web Server are connected through internet.

7. The computerized trading system of claim 1, wherein said market trading data is derived from a list of market participants comprising NASDAQ, S&P 500, DJI and BSE 500.

8. The computerized trading system of claim 1, wherein said market trading data is end of day trading data.

9. The computerized trading system of claim 1, wherein said financial instrument is stock.

10. The computerized trading system of claim 1, wherein said trading is swing trading.

11. The computerized trading system of claim 1, wherein said algorithm used to create a trading chart with signals that provide recommendation for security trade uses Savitzky-Golay smoothing algorithm to smooth candle top and bottom values and identify uptrend and downtrend reversal points from smoothed data.

12. A computerized method for minimizing risks in security trading comprising the steps of:
a. setting up a computer system comprising a frontend computer device with graphical display, wherein said frontend computer device with graphical display is connected to a backend Web Server comprising an algorithm to analyze market data for financial instruments received from a plurality of market participants;
b. receiving market data for financial instruments from plurality of market participants at said Web Server;
c. analyzing said market data for financial instruments received at said Web Server using said algorithm to create trading charts with signals that provide recommendation for security trade;
d. displaying said trading charts with signals that provide recommendation for security trade at said frontend computer device with graphical display; and
e. following said recommendation for security trade displayed at said frontend computer device with graphical display in trading securities.

13. The computerized method for minimizing risks in security trading of claim 12, wherein said signals that provide recommendation for security trade are signals that recommend buying a particular security.

14. The computerized method for minimizing risks in security trading of claim 12, wherein said signals that provide recommendation for security trade are signals that recommend selling a particular security.

15. The computerized method for minimizing risks in security trading of claim 12, wherein said signals that provide recommendation for security trade are signals that recommend selling a particular security specify a percentage of security to be sold.

16. The computerized method for minimizing risk in security trading of claim 12, wherein said financial instrument is stock.

17. The computerized method for minimizing risk in security trading of claim 12, wherein said trade is swing trade.

18. A computer program embodied in a computer readable medium that is executed by a computer for determining and displaying trading trend for securities along with signals that provide recommendation for security trade comprising:
a. receiving market data for financial instruments from plurality of market participants;
b. analyzing said market data for financial instruments to create trading trend along with signals that provide recommendation for security trade;
c. visually displaying the said trading trend along with signals that provide recommendation for security trade;
d. wherein said computer readable medium is located within a backend Web Server;
e. wherein said trading trend along with signals that provide recommendation for security trade is visually displayed in a frontend computer; and
f. wherein said backend Web Server and frontend computer are connected.

19. The computer program embodied in computer readable medium of claim 18, wherein said computer program uses Savitzky-Golay smoothing algorithm to analyze market data for financial instruments to create trading trend along with recommendation for security trade.

20. The computer program embodied in computer readable medium of claim 18, wherein said securities include stocks.
